(19) United States
(12) Patent Application Publication
(10) Pub. No.: US 2013/0323365 A1
(43) Pub. Date: Dec. 5, 2013

(54) ANIMAL FEEDS AND PROCESSES FOR PRODUCING SAME

(71) Applicant: Nick Thomas, Hadleigh (GB)

(72) Inventor: Nick Thomas, Hadleigh (GB)

(21) Appl. No.: 13/484,513

(22) Filed: May 31, 2012

(51) Int. Cl. A23K 1/00; A23K 1/18; A23K 1/20; A23K 1/16; A23K 1/175

(52) U.S. Cl. 426/72; 426/635; 426/636; 426/623; 426/622; 426/630; 426/74; 426/464; 426/463; 426/452; 426/460; 426/311

(57) ABSTRACT

The present invention relates to animal feed and processes for manufacturing the same. In particular, this invention relates to a high fibre, low density, mono-component (monoforage) product with high concentrations of long fibre particles derived from forage material, for feeding to pets and other animals and methods for producing the same.

This invention relates to animal feed (particularly pet food) and processes for manufacturing the same. In particular, this invention relates to a high fibre, low density mono-component (monoforage) product for feeding to pets and other animals and methods for producing the same.

Mono component animal feed/pet food is typically manufactured using either a ‘Pelleting’ or ‘Steam Extrusion’ process. Feed ingredients are made up of various components such as cereals, vegetables and seeds. These products are usually ground and then softened (conditioned) by the addition of heat and/or water. When sufficiently controlled compression is applied to the “conditioned” feed ingredients, they form a dense mass, shaped to conform to the die against which they are pressed by the machinery traditionally used for these processes. Pelleting generally results in the production of a hard, dense (e.g. greater than 600 g/L) product, using finely ground materials which are forced through a die. Steam Extrusion generally refers to a process where ground material is forced through a die using steam and significant force. Steam extrusion generally relies on the cooking of starch, usually contributed to the formulation through the addition of wheat or other cereals. Typically, the product is cooked prior to forming through the die following which the product is dried and cooled. The addition of steam improves production rates, reduces die wear, and improves extrudate quality. Steam conditioning was quickly adopted by the industry and has remained an integral part of the manufacturing process to the present time. Such processing is common in the mass production of live stock and animal feed, and has been adopted as a standard production process for products aimed at the ‘small animal’ and petfood market.

Pelleting feed has generally been found to be useful from a number of aspects in the chain of manufacture, supply and consumption. For example, one purpose of pelleting is to take a finely divided, sometimes dusty, unpalatable and difficult-to-handle feed material and, generally by using heat, moisture and pressure, form it into larger particles. These larger particles are easier to handle, more palatable and usually result in improved feeding results when compared to the unpelleted feed. However, products produced using these processes are generally small pellets (typically, but not limited to, 4-6 mm) which are limited in their concentration of long fibre particles which result from the fibrous ingredients. For example, a typical extruded pet food (e.g. rabbit/guinea pig) has fibre particle sizes typically in the range of only 7% being longer than approx. 1 mm, with the remainder being less than 1 mm. Moreover, the feeds tend to have a relatively high bulk density, typically of greater than 650 g/L (pelleting) and greater than 300 g/L (steam extrusion).

Some advantages of pelleting include improved handling characteristics and enhanced storage capabilities in most bulk facilities, whilst shipping efficiencies are also increased, thereby reducing transportation costs. Moreover, pelleting prevents the segregation of ingredients during consumption by the animal (known as ‘selective feeding’), and as such, feeds are typically referred to as mono-component feeds. By feeding a pelleted feed, the animal is more likely to receive a balanced ration when compared to a traditional muesli mix diet, where the animal may pick and choose its preferred components while leaving less preferred components, leading to a possible lack of a nutritionally-balanced intake. In the livestock industry, it has often been found that animals make better gains on pelleted feed than a meal ration. The most logical reasons are that (a) the heat generated in conditioning and pelleting makes the feedstuffs more digestible by breaking down the starches, (b) the pellet simply puts the feed in a concentrated form, and (c) pelleting minimizes waste during the eating process. When pelleted feed is fed, each animal receives a well-balanced diet by preventing the animal from picking and choosing between ingredients. It also prevents waste.

However, the present inventor has found that while there are benefits to standard pelleted and steam extruded feeds, the efficiency of their presentation to the animal consuming the feed can have significant drawbacks. An evident drawback is that consumption rates are much increased over non-pelleted meal rations. This leads to a sometimes significantly shorter feeding time for the animal, which can have a negative impact on the animal's wellbeing. In this regard, the animal may experience a reduction in environmental enrichment (i.e. increased boredom while the animal is not eating) and also a reduction in dental wear, since the animal is chewing for shorter periods of time. Moreover, existing pelleted and steam extruded feeds have a limited crude fibre content and may only provide short lengths of fibrous particles, which may have various physiological limitations on the consuming animal.

A further drawback to existing practices is that the process of steam extrusion relies on the inclusion of either (usually) wheat or another source of starch, which during the ‘cooking’ process the starch becomes gelatinised and is utilised to ‘bind’ the product together and create the structural integrity of the extrudate. Typically, the minimum wheat content in an extrusion is approx. 20%. As a result of the high proportion of this ingredient in existing products, the resulting feeds have a high starch level, which may not be ideal or appropriate to the target species.

The present inventive process and products do not rely on the inclusion of wheat or other starch based ingredients for their integrity and palatability and as such the resulting feed can provide a significant reduction in starch content, which can be much more appropriate for the target species' nutritional requirements.

Thus, the present invention is directed to providing a high fibre, low density animal feed/petfood, preferably in the format of a mono-component (monoforage) feed, which is designed to deliver a high concentration of long fibre particles to the diet of the target species. The inclusion of such material within a diet can enhance digestive function and faecal/caecotroph consistency through the physiological effects of the increased number/concentration of ‘long’ fibre particles.

Moreover, the present invention is directed to monoforage products which preferably have a lower bulk density than traditional pelleted or extruded products, which results in an increased volume of feed being provided and consumed when compared by weight to a standard pellet or extrusion. This can help to extend the feeding time of the target species, enhancing environmental enrichment (reducing boredom) and increasing dental wear. Thus, the present invention provides a method for extending feeding time in a target species. For example, by providing e.g. 100 g of the inventive product, the animal will be presented with a greater volume of food when compared to providing a comparable weight of a traditional steam extruded product or a traditional pelleted product. As such, the animal will need to eat a greater volume which will take a longer period of time.

Moreover, the present invention is directed to monoforage products which preferably have a low starch content when compared to existing feeds. Such starch content is typically less than approx. 10%. In existing feeds, the starch content is typically about 20% or higher.

The present invention is also directed to processes for manufacturing said high fibre, low density products.

The present invention is also directed towards methods for improving dental wear in a target species, by providing products of the present invention to said target species followed by their consumption. The increased time taken to consume the feed, combined with the presence of long fibre particles, increases the dental wear of the species.

The present invention is also directed towards methods for enhancing digestive function and/or faecal/caecotroph consistency in a target species, by providing products of the present invention to said target species followed by their consumption. The high fibre content and/or the presence of the long fibre particles in the product aid in this regard.

The present invention is also directed towards methods for enhancing environmental enrichment (i.e. reducing boredom), since if the animal is feeding for a longer period of time they will spend less time doing nothing.

The present invention is also directed towards a method for encouraging water consumption in a target species. In this regard, if an animal eats a greater volume of a dry product for a longer period of time, this is likely to increase the frequency and amount the animal drinks. This is particularly beneficial if the target species has e.g. a urinary tract disorder.

Thus, in one embodiment of the present invention there is provided a process for producing a mono-component animal feed; said process comprising the steps of: (a) manipulating one or more types of forage material such that at least about 20% of their resulting fibre particle sizes are over about 1 mm in length; (b) mixing said collection of fibrous particles with one or more additional ingredients in the presence of water to form a dough; (c) passing said dough into and/or through a die; and (d) drying said dough.

Preferably, an additional step can be carried out between steps (c) and (d), said additional step comprising portioning the dough into appropriately shaped and sized pieces to assist storage/packaging/handling and feeding, without compromise to the technical benefits as described herein.

Preferably the manipulation of one or more types of forage material is carried out by chopping and/or grinding.

Yet more preferably, at least 20% of the weight of the ingredients (not including water) used in the process is forage material, preferably at least 30%, preferably at least 40%, preferably at least 50%, preferably at least 60%, preferably at least 70%, preferably at least 75%, preferably at least 80%, preferably at least 85%, preferably at least 90%, preferably at least 95%, preferably at least 96%, preferably at least 96%, preferably at least 97%, preferably at least 98%, sometimes up to 99% or 100%. Preferably the forage material makes up between approx. 40%-98% of the product, preferably between approx. 50%-90%, preferably between approx 50%-80%, preferably between approx 50%-75%.

Preferably the forage material is selected from the group comprising alfalfa, grasses, hay (e.g. Timothy hay), straw, gluten feeds, oat hulls, rice, bran. Combinations of one or more types of forage material can be used, such as two, or three types.

In preferred embodiments of the present invention, the resulting product has a crude fibre content of at least approx. 20% (dry weight of product), preferably at least 25%, preferably at least 30%, preferably at least 35%, preferably at least 40%. In preferred embodiments, the crude fibre content is between about 20% to 40%.

Yet more preferably, more than about 20% of the fibrous particle sizes are longer than about 1.5 mm.

In some aspects, additional ingredients may include one or more cereals, vegetables, seeds, nuts, legumes, herbs, vitamins, minerals, and fats, or combinations of said ingredients. More preferably the additional ingredients further comprise a binder in order to assist in binding the constituents of the Monoforage feed, preferably present in an amount of between 1% and 5% of total weight of product, yet more preferably being xanthan gum.

In preferred aspects of the invention, steps (a) to (c) are carried out at ambient (e.g. room) temperature. Preferably in step (d) the dough is dried to a moisture content of less than 15%, preferably less than 12%, optionally at a temperature of approx 130° C.-180° C. for approx 25-60 mins.

In preferred aspects of the present invention, the resulting product has a bulk density of less than about 300 g/L, preferably less than about 250 g/L, preferably less than about 200 g/L.

In preferred aspects of the present invention, the resulting product has a starch content of less than 10%, preferably less than 9%, preferably less than 8%, preferably less than 7%, preferably less than 6%, preferably less than 5%.

In another embodiment of the present invention there is provided a product manufactured by the above-mentioned process.

In another embodiment of the present invention, there is provided a mono-component animal feed comprising forage material, wherein said forage material is present in particle sizes wherein more than about 20% of said particle sizes are longer than about 1 mm.

Preferably more than about 20% of said particle sizes are longer than about 1.5 mm.

Yet more preferably, at least 20% of the weight of the ingredients (not including water) is forage material, preferably at least 30%, preferably at least 40%, preferably at least 50%, preferably at least 60%, preferably at least 70%, preferably at least 75%, preferably at least 80%, preferably at least 85%, preferably at least 90%, preferably at least 95%, preferably at least 96%, preferably at least 96%, preferably at least 97%, preferably at least 98%, sometimes up to 99% or 100%. Preferably the forage material makes up between approx. 40%-98% of the product, preferably between approx. 50%-90%, preferably between approx 50%-80%, preferably between approx 50%-75%.

In preferred embodiments of the present invention, the product has a crude fibre content of at least approx. 20% (dry weight of product), preferably at least 25%, preferably at least 30%, preferably at least 35%, preferably at least 40%. In preferred embodiments, the crude fibre content is between about 20% to 40%.

In certain aspects of the present invention, the forage material can be selected from the group comprising alfalfa, grasses, hay (e.g. Timothy hay), straw, gluten feeds, oat hulls, rice, bran. Combinations of one or more types of forage material can be used, such as two, or three.

Preferably the feed contains one or more further ingredients, said ingredients including one or more cereals, vegetables, seeds, nuts, legumes, herbs, vitamins, minerals, and fats, or combinations of said ingredients.

In certain aspects of the present invention, the feed further comprises a binder in order to assist in binding the constituents of the mono-component feed, preferably wherein said binder is present in an amount of between 1% and 5% of total (dry) weight of product, preferably wherein said binder is xanthan gum.

In preferred aspects of the present invention, the feed has a bulk density of less than about 300 g/L, preferably less than about 250 g/L, preferably less than about 200 g/L.

In a further embodiment of the present invention there is provided a method of enhancing dental wear in an animal, said method comprising providing to the animal an animal feed as described herein.

In a further embodiment of the present invention there is provided a method for enhancing digestive function and/or faecal/caecotroph consistency in a target species, said method comprising providing to the animal an animal feed as described herein.

The present invention is also directed towards methods for enhancing environmental enrichment (i.e. reducing boredom), since if the animal is feeding for a longer period of time they will spend less time doing nothing.

The present invention is also directed towards a method for encouraging water consumption in a target species. In this regard, if an animal eats a greater volume of a dry product for a longer period of time, this is likely to increase the frequency and amount the animal drinks. This is particularly beneficial if the target species has e.g. a urinary tract disorder.

The invention will now be described in more detail, with reference to the figures in which:

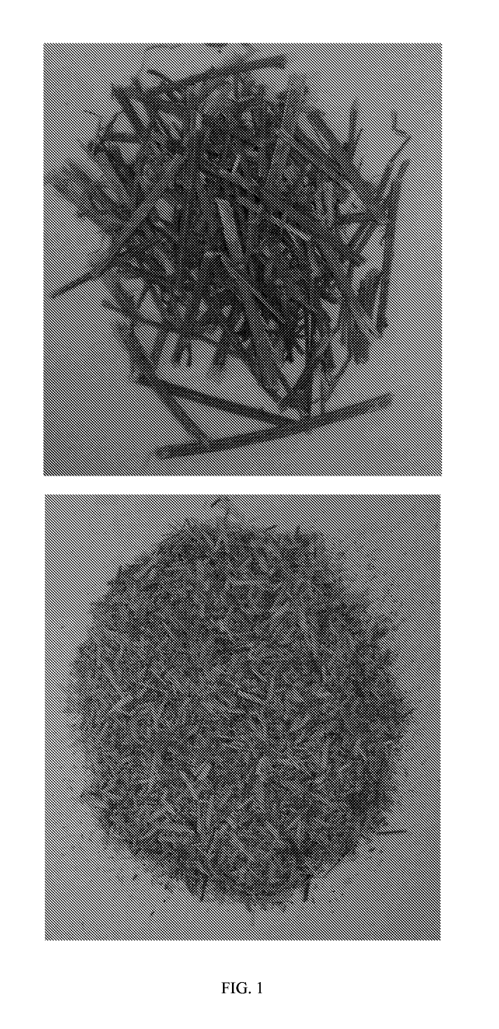

FIG. 1 depicts a ‘before and after’ representation of a forage material used in the present invention, with the raw forage material prior to processing and the resulting smaller particle sizes achieved after it has been processed (e.g. chopped/ground).

The products of the present invention are mono-component, so-called monoforage products, and contain high quantities of forage material (typically in the range of between about 40%-100%, preferably between about 50% to 90%). The products of the present invention are suitable for feeding to animals, such as livestock (pigs, cows, sheep, etc.) and in particular are designed for pets (such as rabbits, guinea pigs chinchillas, degus, horses, etc.).

Some animals when fed non-pelleted food (e.g. muesli mix diets) eat only the ingredients they prefer, which means they risk omitting all of the required components for a balanced diet. To combat this, mono-component feeds have been developed. Such feeds assist in preventing selective feeding, since all of the animal's nutritional requirements are presented in an easy-to-eat single component. The products of the present invention have a high content of forage material (e.g. over approx. 50%, preferably over approx. 70%), resulting in a relatively high crude fibre content (e.g. approx. 20%-approx. 40%), optionally with other ingredients such as cereals, vegetables, herbs, seeds, nuts, legumes, vitamins and minerals, combined to create a nutritionally balanced diet. Preferably the monoforage product of the present invention is nutritionally balanced, and advantageously can preferably help promote dental wear, reduce boredom, enhance digestive function, and enhance water uptake.

In particular, the products of the present invention preferably contain relatively high levels of crude fibre. When discussing ‘crude fibre’, it is intended to mean the analytical fibre content of the product, which primarily results from the fibrous forage material (being the processed (e.g. chopped/ground) fibrous ingredients (i.e. forage material) used in the product). It is a well known term in the art, referring to an analytical measure. Such levels of crude fibre are preferably over about 15% of the dry weight of the product, more preferably over about 20%, more preferably over about 25%, more preferably over about 30%. In some embodiments of the present invention, the fibre content of the product is between about 20-50% of the dry weight of the product, preferably between about 25-40%, more preferably between about 25-35%, more preferably between about 27-34%. In some circumstances, the fibre content may be over 50%.

The preferred composition of the monoforage products of the present invention can be varied depending on the target species and/or depending on the particular diet that is required for the animal. For example, an animal that requires a particular diet in order to manage its weight might be fed a monoforage product that has a higher amount of crude fibre, such as over 30% (e.g. 34%). A fibre level such as this will also allow for a lower energy content.

Moreover, the products of the present invention preferably contain a high level of long fibre particles. In this regard, the products of the present invention preferably contain fibre particles wherein over about 20% of the fibrous material is longer than about 1 mm. Preferably more than about 25% of the fibrous material is over about 1 mm in length. In some embodiments more than about 30% of the fibrous material is over about 1 mm in length. In some embodiments more than about 35% of the fibrous material is over about 1 mm in length. In some embodiments more than about 40% of the fibrous material is over about 1 mm in length. Preferably, between about 20% and 50% of the fibrous material is over about 1 mm in length.

In certain embodiments of the present invention, more than about 20%, preferably about 25%, 30%, 35%, 40%, 45% of the fibrous material exceeds 1.5 mm in length.

Preferably between approx. 20-80% of the fibre lengths exceed 2 mm in length, more preferably approx. 50-80%.

In certain embodiments, between approx. 15-60% of the fibre lengths exceed 3 mm in length, more preferably between approx. 15-50%.

In yet further embodiments, between approx. 10-40% of the fibre lengths exceed 4 mm in length, more preferably between approx. 10-30%.

In yet further embodiments, between approx. 10-30% of the fibre lengths exceed 5 mm in length, more preferably between approx. 10-20%.

In some embodiments, there may be a proportion of fibre lengths that exceeds e.g. 6, 7, 8, 9 or 10 mm. These proportions may be between approx. 2-20% of the fibre lengths, for example. In some embodiments, there may be a proportion of fibre particles over 15 mm in length.

This is in stark contrast to existing pelleted feeds, which may only comprise in the region of <10% (e.g. 7%) of fibrous material being over 1 mm in length.

As with the proportions of forage material in the monoforage product, the skilled person will be aware that feeds for different species may differ in their crude fibre content and/or fibre lengths. This may be because of the different forage material that is used to make different animals' feeds, and different methods of grinding/chopping the forage material into their small lengths. For example, the use of e.g. alfalfa vs. Timothy hay may result in monoforage products with different crude fibre contents in addition to differences in other nutrient levels.

The person of skill in the art will be aware of how to ascertain the particle lengths of the fibrous material in the products of the present invention. For example, analysis of a batch of product of the invention, by e.g. separating and sorting the ‘insoluble’ fibrous material from the remaining ingredients, and then measuring the lengths of the fibrous material to ascertain the proportions of different sized particles will provide the result.

It is believed that due to the presence of these long fibre particles in the product of the present invention, the inventive monoforage product is believed to be unique for its low bulk density in comparison to existing animal feeds/pet foods. In this regard, the bulk density of the products of the present invention is preferably less than about 300 g/L. In more preferred embodiments, the density is preferably less than about 250 g/L, more preferably less than about 200 g/L. In other embodiments of the present invention, the bulk density of the monoforage product can be between about 130 and 280 g/L, preferably between about 150 and 250 g/L, preferably between about 150 and 200 g/L, preferably between about 150 and 180 g/L.

Bulk density may be measured by any suitable method. A crude way of measuring bulk density is e.g. by filling a container of known volume with the product and weighing as appropriate (whilst factoring out the weight of the container).

As will be discussed in more detail below, the process of forming the monoforage product is preferably undertaken at ambient temperature (apart from any required drying step). As such, in the absence of any change of state when formed (i.e. cooking/setting), the forage components of the dough have the same physical characteristics at the end of the process as they have prior to forming. When the dough is processed (formed and cut) into appropriate size pieces according to the requirements of the target species, due to the content of ‘long’ fibrous particles, which tend to have a semi-flexible and irregular structure and therefore do not sit together evenly unless forced, they will naturally maintain or return to an ‘uncompressed’, low bulk density status at equilibrium. The physical structure and bulk density of the final product of the invention is achieved and maintained at the point where the moisture content is such that the product is ‘dry’—e.g. moisture content of less than about 12%. Since the step of drying the final product is separate (in time) to that of the forming, the long fibre particles within the monoforage product of the invention generally are able return to their natural equilibrium (i.e. a low bulk density) prior to being set (i.e. by reducing moisture content).

In some embodiments of the product of the present invention, the monoforage particle size can range from about 1 cm to about 20 cm, preferably from about 4 cm to about 8 cm.

Thus, the products of the present invention comprise a high fibre diet that aims to satisfy the natural nutritional and physiological needs of the consuming animal. It is important that pets are able to forage and chew to satisfy their natural feeding behaviour. With longer fibre particles and a larger portion volume than existing pelleted or steam extruded feeds, the products of the present invention can extend the animal's feeding time, promoting dental wear and enhancing environmental enrichment through the reduction of boredom.

As discussed, the fibrous material used in the present invention is forage material. Forage material is a term well known in the industry, and generally refers to plant material (mainly plant leaves and stems) destined to be eaten by animals. Various grasses and legumes, and their derivatives, are typically regarded as forage materials. Non-limiting examples of forage materials include e.g. Lucerne (e.g. alfalfa), grasses, hay (e.g. Timothy hay), straw, gluten feed, oat hulls, rice, bran, etc.

One or more different forage materials can be used in a single feed, depending on the desired final product. For example, alfalfa and Timothy hay may be combined in a single formulation.

As well as the fibrous forage material(s) used in the products of the present invention, there are also other ingredients that can be used. There is a large variety of other useful ingredients, and the skilled person will know which ones may be included depending on the species that the monoforage product is destined to be eaten by and any other dietary requirements that are of interest. For example, it may be advantageous to feed rabbits over 4 years a monoforage product that has a blend of herbs contained with it, as these comprise antioxidants which are beneficial to the rabbit. Rabbits between 4-20 weeks old, or those that are pregnant and/or lactating may benefit from monoforage feeds that are high in protein, antioxidants, and optionally which contain ingredients which are high in lutein, alpha lipoic acid and/or coenzyme Q10 (such an ingredient is e.g. spinach).

Common other ingredients are e.g. peas, maize, beetroot, vegetables, oats, wheat, seeds (of various origins), soya beans and soya bean hulls, carob beans and husks, herbs, spices, vitamins, minerals oils (soya oil) etc.

Typical additional ingredients include vitamins (e.g. vitamin A, vitamin C, etc.), minerals (e.g. calcium, sodium, phosphorous, etc.) antioxidants (present as stand-alone ingredients or as part of other ingredients), proteinaceous ingredients (such as peas, wheat, soybean, etc.), herbaceous ingredients (such as e.g. dandelion, fennel, nettle, spinach, etc.), fats and oils (e.g. linseed, fenugreek, omega 3/6, etc.).

Exemplary ratios of analytical constituents of the ingredients in the monoforage products can range from e.g. 10-20% crude protein, 20-40% crude fibre, 2-5% oils and fats, 6-10% inorganic matter (e.g. ash), 0.4-1% calcium, 0.3-0.8% phosphorous, 0-0.6% sodium.

It will be appreciated that due to the high fibre content of the feeds of the present invention, the binding of the ingredients together may be compromised to an extent. Thus, in certain embodiments of the present invention, the monoforage feed particles further comprise a binder component to assist in maintaining the integrity of the feed. It is preferred to have an efficient binder so as not to require a high concentration of binder in order to achieve suitable binding of the monoforage components. Preferably, the amount of binder to be used in the monoforage product is less than about 10% of the total weight of the ingredients, preferably less than about 8%, preferably less than about 6%, preferably less than about 5%, preferably in the range of about 1% to 5%, preferably in the range of about 2% to 4%, preferably between about 2% and about 3%. In this regard, the present inventors have found that xanthan gum is a particularly useful binder. The skilled person will be aware that other useful binders exist, such as Konjac mannon, starch (modified or unmodified), tara gum, cassia gum, gelatin, locust bean gum, guar gum, etc., and various combinations of said gums. Preferably such a gum, or combinations of gums, is added at approx. 2-2.5% of the weight of the product. Lignosulphonate binders may also be used.

In alternative embodiments of the present invention, other binders may be used which may be less efficient than more efficient binders. For example, various flours (e.g. wheat flour) and other plant products that offer a high starch content may be used, and the skilled person will be aware that the quantities required of these more inefficient binders may be higher than more efficient binders (e.g. 20-30% of total weight of product).

Preferably, however, the amount of starch in the product of the present invention is present at less than about 10%, preferably less than about 8%, preferably less than about 6%, preferably less than about 5%.

Preferably, the products of the present invention comprise no added sugar.

In further embodiments of the present invention, there are provided methods of manufacturing the monoforage feeds as hereinbefore described.

Thus, in particular aspects of the invention, a monoforage product is produced using a formulation incorporating a variety of raw materials, of which preferably >50% is forage material.

Typically, forage material is supplied (by a variety of agricultural growers or feed manufacturers) to the manufacturing facility after it has been harvested and dried. It will be appreciated that the drying step often depends on the specific forage material being dealt with. For example, hay is typically sun-dried, whilst lucerne (alfalfa) is typically dehydrated.

The (typically) dried forage material is received at the facility, and is manipulated into smaller fibrous particles. Typically, such processing is achieved by chopping and/or grinding. This is typically carried out by processing the material in its ‘common state’ through a hammer mill or tub grinder, which grinds the material in the container until it is of sufficient length to be able to be separated by a screen. Screen size of approx. 4-10 mm, e.g. 8 mm, 6 mm, has been found to produce appropriate size particles, but other sizes may be used to counteract natural variation of raw materials. The resulting product (which can comprise lengths of fibre of e.g. 10-12 mm using a 8 mm screen) may be passed over a grading sieve to remove/reduce small fines & dust (e.g. <0.25 mm), and over sized particles (e.g. >20 mm). Small fines and dust may be discarded from this process, whereas over sized particles may be recycled through the system until the desired particle size is achieved.

The forage material is processed until it comprises fibre particles wherein over about 20% of the particles are longer than about 1 mm. Preferably more than about 25% of the particles are over about 1 mm in length. In some embodiments more than about 30% of the particles are over about 1 mm in length. In some embodiments more than about 35% of the particles are over about 1 mm in length. In some embodiments more than about 40% of the particles are over about 1 mm in length. Preferably, between about 20% and 80% of the fibrous material is over about 1 mm in length.

In certain embodiments of the present invention, more than about 20%, preferably about 25%, 30%, 35%, 40%, 45% of the fibres exceeds 1.5 mm in length.

Preferably between approx. 20-80% of the fibre lengths exceed 2 mm in length, more preferably approx. 50-80%.

In certain embodiments, between approx. 15-60% of the fibre lengths exceed 3 mm in length, more preferably between approx. 15-50%.

In yet further embodiments, between approx. 10-40% of the fibre lengths exceed 4 mm in length, more preferably between approx. 10-30%.

In yet further embodiments, between approx. 10-30% of the fibre lengths exceed 5 mm in length, more preferably between approx. 10-20%.

In some embodiments, there may be a proportion of fibre lengths that exceeds e.g. 6, 7, 8, 9 or 10 mm. These proportions may be between approx. 2-20% of the fibre lengths, for example. In some embodiments, there may be a proportion of fibre particles over 15 mm in length.

Once the desired length of fibrous (forage) material is achieved, it then proceeds to the mixing step. In this regard, the forage material is mixed with other desired raw materials, if any. Dependant on the desired specification of the finished product, the raw materials used may vary in inclusion level and type. Finished product specifications may differ in ingredient selection, inclusion level, and nutritional profile dependant on the target species (or life stage) for which the monoforage diet is being formulated.

The person of skill in the art will be aware of the various ingredients that may be incorporated in the manufacture of the monoforage products of the present invention. Such ingredients may be, e.g. vitamins (e.g. vitamin A, vitamin C, etc.), minerals (e.g. calcium, sodium, phosphorous, etc.), antioxidants (present as stand-alone ingredients or as part of other ingredients), proteinaceous ingredients (such as peas, wheat, soybean, etc.), herbaceous ingredients (such as e.g. dandelion, fennel, nettle, spinach, etc.), fats and oils (e.g. linseed, fenugreek, omega 3/6, etc.), and stock ingredients such as peas, maize, oats, wheat, various varieties of seeds, etc.

If one or more binders are to be used to help bind together the components in the final product, then they may also be added at this stage.

Preferably, the dry ingredients are mixed prior to the addition of water, which helps to ensure the ingredients are properly distributed before a dough is formed. A typical timescale for mixing the dry ingredients is e.g. 10 seconds.

All materials are mixed with water (which does not need to be hot/warm) to produce a moist dough. Water inclusions are as appropriate to enable forming, but typically about 1 to 2 L/kg of dry ingredients is appropriate, such as 1.2 to 1.4 L/kg of dry ingredients. A spiral mixer is a suitable tool for performing the wet mixing step.

It will be appreciated that not all of the ingredients need to be mixed together before the addition of water. In some aspects of the present invention, some of the ingredients are mixed together with water, and other ingredients are then added to the formed dough and mixed in, optionally with additional water if required.

The mixing continues until the dough (now containing substantially all, and preferably all, of the required ingredients) is soft to the touch and does not ‘ball’ when compressed in the palm. The dough is ‘short’ and contains no gelatinous stretch and structure that may be associated to bread dough. Thus, it typically will break apart when manipulated. General mixing time for a 25 kg (dry ingredients only) mix is approximately 4 minutes. In some aspects of the present invention there is no or little standing time. In other aspects, the mix can be left to stand—for example there may be standing time involved while a mix waits to be transferred to the forming line).

After the dough has achieved the desired consistency and is thoroughly mixed, it is transferred to appropriate machinery in order to carry out the next step of the process, which is to mechanically force the dough through an appropriate die. Non-limiting examples of machines that can be used to carry out this step include e.g. a ‘Piston filler’ (e.g. Ramon SC50 piston filler (larger and smaller models available)) or ‘Continuous Vacuum Filler’ (e.g. Vemag V500 continuous filler, manufactured by Vemag). Other makes and models of forming equipment using similar designs are available. Additionally, machinery of alternative operation and design such as a rotary moulder may also be utilised to form the dough into suitably sized particles.

In operation, a piston filler typically relies on the dough being placed into a compression chamber which is then compressed by a piston. The piston forces the dough out of a nozzle/die. One drawback with such equipment is that it requires production to stop each time the filler requires replenishing. As such, a continuous filler is the preferred method for large scale production.

In this regard, a continuous filler can run continuously provided a hopper remains at least partially full of dough. Typically, a large mechanically driven screw (typically a double screw) conveys the dough from the hopper into a forming horn. An insert (die) of appropriate size is located in the forming horn. The dough is driven through the forming horn by the back pressure of product build up created by the double screw, and out of the insert which dictates and creates the shape.

After the dough is forced out of the insert of the machine being used, a guillotine or similar device can then be used to cut the formed dough into lengths appropriate to the desired size of the finished product. In certain embodiments, the insert preferably forms pieces with a squared profile. This may be advantageous in that it prevents the monoforage product from rolling (e.g. off conveyor belts) during the remainder of the manufacturing process. However, in alternative embodiments, the shape of the die may be changed to produce a product of different profile (e.g. circular, polygonal, etc.). In certain embodiments, the diameter/width of the resulting formed dough may be between about 5 mm and 10 mm. The length of the formed dough at which the guillotine cuts can be varied according to the requirements of the target species or the physical appearance deemed appropriate. Typically the length of the formed dough may be about 1 cm to about 20 cm.

In preferred embodiments of the present invention, the dough is formed at ambient temperature through a dye/insert of appropriate size and shape for the desired product.

In preferred embodiments of the present invention, the process of manufacturing the monoforage product up to the drying step is carried out ambient temperatures, i.e. there is no significant heating of the fibrous material during the process before the step of drying the dough, which may preserve better the physical and biochemical properties of the ingredients used in the process. For example, it allows the fibrous material to maintain its physical structure and assist in providing a final monoforage product that has a low bulk density.

The formed dough is dried until the desired moisture content is achieved. This is typically less than 12%, preferably less than 10%.

Drying may be achieved by conveying the formed dough to an oven where it is baked. Oven temperatures and times are typically about 160° C. for about 35-45 minutes, dependant on the size of the particles being processed. Lower temperatures may be used, but result in a greater time required to reach a suitable moisture content. In some embodiments of the present invention, temperatures of 130° C.-180° C. for approx 25-60 mins can be useful. Higher temperatures may result in burning of the outer ‘crust’ whilst leaving the centre of the product wet. The skilled person is aware of the variety of methods for baking, e.g. 220° C. for 5 minutes (open oven steam vents), followed by a significant and generally quick drop in temp.

In alternative embodiments of the methods of present invention, the drying step may comprise the use of a ‘warm room’ (at e.g. approx. 60° C.) optionally with dehydration units installed. Such a method may involve a significantly longer process (circa 18-24 hrs for moisture reduction) but enables significant up-scaling of total production yield.

The skilled person will be aware that other drying methods can be used, such as the use of a ‘continuous oven’ or a ‘spiral oven’. In this scenario, the product exits the forming machine and is directly conveyed into a continuous oven or spiral oven. I.e. it enters the oven wet, and exits it dry. Baking times and temperatures are similar to those as above. The product is then allowed to cool to ambient temperature prior to packaging. The use of cooling tunnels may be advantageous on large scale continuous production.

After the monoforage product is sufficiently dry, it is then packaged and is ready for sale and/or consumption.

### EXAMPLES

### Rabbit Feed

An example of a monoforage rabbit feed of the present invention is shown below:

Feeding Guide:

The average adult rabbit (2.5 kg) will require approx. 75 g of monoforage feed per day (or approx. 30 g/Kg body weight/day). The product may be fed freely, however weight should be monitored regularly.

Fresh hay and water should always be available.

### Composition

Timothy hay, alfalfa stalks, wheat flour, soybean flour, ground peas, locust bean meal, alfalfa protein extract, flaked oats, linseed, soya oil, salt, dicalcium phosphate. May contain genetically modified soya.

Forage material: 70.2%

Legumes: 11.0%

Cereals: 8.0%

Protein Extracts: 2.5%

Binders: 2.5%

Seeds: 1.5%

Vitamins: 2.0%

Oils: 1.5%

Flavourings 0.8%

Analytical Constituents

Crude protein 14.0% Crude fibre 30.0% Crude oils and fats 3.5% Crude ash 7.5% Calcium 0.8% Phosphorus 0.4% Sodium 0.4%

Nutritional Additives/KG

Vitamin A 15000 IU, vitamin D3 1500 IU, vitamin E 60 mg, ferrous sulphate monohydrate 152 mg, calcium iodate anhydrous 1.5 mg, copper sulphate pentahydrate 20 mg, manganese oxide 38 mg, zinc oxide 62 mg, sodium selenite 0.2 mg.

### Guinea Pig Feed

An example of a monoforage guinea pig feed of the present invention is shown below:

Feeding Guide:

The average adult guinea pig will require approx. 30-50 g of monoforage feed per day (or approx. 40 g/Kg body weight/day). The product may be fed freely, however weight should be monitored regularly.

Fresh hay and water should always be available.

### Composition

Timothy hay, alfalfa stalks, ground peas, soybean flour, wheat flour, locust bean meal, flaked oats, alfalfa protein extract, linseed, soya oil, salt, dicalcium phosphate. May contain genetically modified soya.

Forage material: 57.2%

Legumes: 20.5%

Cereals: 11.5%

Protein Extract: 2.5%

Binders: 2.5%

Vitamins: 2.0%

Seeds: 1.5%

Oils: 1.5%

Flavourings 0.8%

Analytical Constituents

Protein 16.0% Crude fibre 22.0% Fat content 3.5% Inorganic matter 7.5% Calcium 0.6% Phosphorus 0.5%

Nutritional Additives/Kg

Vitamin A 23000 IU, vitamin C 1000 mg, vitamin D3 1500 IU, vitamin E 60 mg, ferrous sulphate monohydrate 152 mg, calcium iodate anhydrous 1.5 mg, copper sulphate pentahydrate 20 mg, manganese oxide 38 mg, zinc oxide 62 mg, sodium selenite 0.2 mg

All patents and publications mentioned in the specification are indicative of the levels of skill of those skilled in the art to which the invention pertains. All references cited in this disclosure are incorporated by reference to the same extent as if each reference had been incorporated by reference in its entirety individually.

One skilled in the art would readily appreciate that the present invention is well adapted to carry out the objects and obtain the ends and advantages mentioned, as well as those inherent therein. The methods and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Preferred embodiments of the present invention are as follows:

A. A process for producing a mono-component animal feed; said process comprising the steps of:
(a) manipulating one or more types of forage material such that at least about 20% of their resulting fibrous particle sizes are over about 1 mm in length;
(b) mixing said collection of fibrous particles, optionally with one or more additional ingredients, in the presence of water to form a dough;
(c) passing said dough into and/or through a die; and
(d) drying said dough.

B. The process of A, wherein an additional step is carried out between steps (c) and (d), said additional step comprising portioning the dough into appropriate sized particles suitable for feeding to the target species.

C. The process of A or B, wherein said manipulation of one or more types of forage material is carried out by chopping and/or grinding.

D. The process of any of A-C, wherein at least about 20% of the weight of the ingredients (not including water) used in the process is forage material, preferably at least about 30%, preferably at least about 40%, preferably at least about 50%, preferably at least about 60%, preferably at least about 70%, preferably at least about 75%, preferably at least about 80%, preferably at least about 85%, preferably at least about 90%, preferably at least about 95%, preferably at least about 96%, preferably at least 97%, preferably at least about 98%, preferably at least about 99%.

E. The process of any of A-D, wherein the crude fibre content of the feed is at least about 20%, preferably at least about 25%, preferably at least about 30%, preferably at least about 35%, preferably at least about 40%.

F. The process of any of A-E, wherein said forage material is selected from the group comprising alfalfa, grasses, hay (e.g. Timothy hay), straw, gluten feeds, oat hulls, rice, bran.

G. The process of any of A-F, wherein more than about 20% of the fibrous particle sizes are longer than about 1.5 mm.

H. The process of any of A-G, wherein between approx. 20-80% of the fibre lengths exceed 2 mm in length, and/or wherein between approx. 15-60% of the fibre lengths exceed 3 mm in length, and/or wherein between approx. 10-40% of the fibre lengths exceed 4 mm in length, and/or wherein between approx. 10-30% of the fibre lengths exceed 5 mm in length.

I. The process of any of A-H, wherein said additional ingredients may include one or more cereals, vegetables, seeds, nuts, legumes, herbs, vitamins, minerals, fats and combinations of said ingredients.

J. The process of any of A-I, wherein said additional ingredients further comprise at least one binder in order to assist in binding the constituents of the mono-component feed.

K. The process of J, wherein said binder is present in an amount of between about 1% and about 5% of total weight of product.

L. The process of J or K, wherein said at least one binder comprises xanthan gum.

M. The process of any of A-L, wherein the content of the starch in the feed is less than approx. 10%.

N. The process of any of A-M, wherein steps (a) to (c) are carried out at ambient temperature.

O. The process of any of A-N, wherein in step (d) the dough is dried to a moisture content of less than about 12%, preferably less than about 10%.

P. The process of O, wherein drying is carried out at a temperature of approx 130° C.-180° C. for approx 25-60 mins.

Q. The process of O, wherein drying is carried out in a ‘warm room’, optionally with dehydration units.

R. The process of any of A-Q, wherein the resulting product has a bulk density of less than about 300 g/L, preferably less than about 250 g/L, preferably less than about 200 g/L.

S. The process of any of A-R, wherein after drying the resulting product is packaged.

T. A product obtainable by the process of any of the preceding embodiments.

U. A mono-component animal feed comprising forage material, wherein said forage material is present in particle sizes wherein more than about 20% of said particle sizes are longer than about 1 mm.

V. The mono-component animal feed of U, wherein more than about 20% of said particle sizes are longer than about 1.5 mm, preferably wherein between approx. 20-80% of the fibre lengths exceed 2 mm in length, and/or wherein between approx. 15-60% of the fibre lengths exceed 3 mm in length, and/or wherein between approx. 10-40% of the fibre lengths exceed 4 mm in length, and/or wherein between approx. 10-30% of the fibre lengths exceed 5 mm in length.

W. The mono-component animal feed of U-V, wherein at least about 50% of the dry weight of the product is from forage material.

X. The mono-component animal feed of W, wherein said forage material is selected from the group comprising alfalfa, grasses, hay (e.g. Timothy hay), straw, gluten feeds, oat hulls, rice, bran, or combinations thereof.

Y. The mono-component animal feed of U-X, wherein the crude fibre content of the feed is at least about 20%, preferably at least about 25%, preferably at least about 30%, preferably at least about 35%, preferably at least about 40%.

Z. The mono-component animal feed of U-Y, wherein said feed contains one or more further ingredients, said ingredients including one or more cereals, vegetables, seeds, nuts, legumes, herbs, vitamins, minerals, fats, or combinations of said ingredients.

AA. The mono-component animal feed of U-Z, wherein said feed further comprises at least one binder in order to assist in binding the constituents of the mono-component feed.

BB. The mono-component animal feed of AA, wherein said binder is present in an amount of between about 1% and about 5% of total weight of product.

CC. The mono-component animal feed of BB, wherein said at least one binder comprises xanthan gum.

DD. The mono-component animal feed of U-CC, wherein said feed has a bulk density of less than about 300 g/L, preferably less than about 250 g/L, preferably less than about 200 g/L.

EE. The mono-component animal feed of U-DD, wherein the content of the starch in the feed is less than approx. 10%.

1. A mono-component animal feed comprising forage material, wherein said forage material is present in particle sizes wherein more than about 20% of said particle sizes are longer than about 1 mm.

2. The mono-component animal feed of claim 1, wherein between approx. 20-80% of the fibre lengths exceed 2 mm in length.

3. The mono-component animal feed of claim 1, wherein at least about 50% of the dry weight of the product is from forage material.

4. The mono-component animal feed of claim 1, wherein said forage material is selected from the group comprising alfalfa, grasses, hay (e.g. Timothy hay), straw, gluten feeds, oat hulls, rice, bran, or combinations thereof.

5. The mono-component animal feed of claim 1, wherein the crude fibre content of the feed is at least about 20%.

6. The mono-component animal feed of claim 1, wherein said feed contains one or more further ingredients, said ingredients including one or more cereals, vegetables, seeds, nuts, legumes, herbs, vitamins, minerals, fats, or combinations of said ingredients.

7. The mono-component animal feed of claim 1, wherein said feed further comprises a binder in order to assist in binding the constituents of the mono-component feed, wherein said binder is preferably present in an amount of between about 1% and about 5% of total weight of product.

8. The mono-component animal feed of claim 1, wherein said feed has a bulk density of less than about 300 g/L, preferably less than about 250 g/L, preferably less than about 200 g/L.

9. The mono-component animal feed of claim 1, wherein the content of the starch in the feed is less than approx. 10%.

10. A process for producing a mono-component animal feed as claimed in claim 1; said process comprising the steps of:
(a) manipulating one or more types of forage material such that at least about 20% of their resulting fibrous particle sizes are over about 1 mm in length;
(b) mixing said collection of fibrous particles, optionally with one or more additional ingredients, in the presence of water to form a dough;
(c) passing said dough into and/or through a die; and
(d) drying said dough.

11. The process of claim 10, wherein an additional step is carried out between steps (c) and (d), said additional step comprising portioning the dough into appropriate sized particles suitable for feeding to the target species.

12. The process of claim 10, wherein said manipulation of one or more types of forage material is carried out by chopping and/or grinding.

13. The process of claim 10, wherein at least about 50% of the weight of the ingredients (not including water) used in the process is forage material.

14. The process of any claim 13, wherein said forage material is selected from the group comprising alfalfa, grasses, hay (e.g. Timothy hay), straw, gluten feeds, oat hulls, rice, bran.

15. The process of claim 10, wherein the crude fibre content of the feed is at least about 20%.

16. The process of claim 10, wherein between approx. 20-80% of the fibre lengths exceed 2 mm in length.

17. The process of claim 10, wherein said additional ingredients may include one or more cereals, vegetables, seeds, nuts, legumes, herbs, vitamins, minerals, fats, or combinations of said ingredients.

18. The process of claim 17, wherein said additional ingredients further comprise a binder in order to assist in binding the constituents of the mono-component feed.

19. The process of claim 10, wherein steps (a) to (c) are carried out at ambient temperature.

20. The process of claim 10, wherein the resulting product has a bulk density of less than about 300 g/L, preferably less than about 250 g/L, preferably less than about 200 g/L.
